(19) United States
(12) Patent Application Publication
(10) Pub. No.: US 2013/0273226 A1
(43) Pub. Date: Oct. 17, 2013

(54) FAT REPLACER COMBINATION FOR PARTIAL OR TOTAL SUBSTITUTION OF FAT IN FOOD PRODUCTS, AND A FOOD PRODUCT COMPRISING THE SAME

(71) Applicants: Celso Jose da Silva, Sao Paulo (BR); Luciano Fachin, Sao Paulo (BR); Erivelton Peixoto, Sao Paulo (BR); Fernanda Carvalho, Sao Paulo (BR); Ana Elisa Romani De Pontes, Sao Paulo (BR); Fernanda Zaccarelli Davoli, Sao Paulo (BR); Sebastiao Mendes, Sao Paulo (BR)

(72) Inventors: Celso Jose da Silva, Sao Paulo (BR); Luciano Fachin, Sao Paulo (BR); Erivelton Peixoto, Sao Paulo (BR); Fernanda Carvalho, Sao Paulo (BR); Ana Elisa Romani De Pontes, Sao Paulo (BR); Fernanda Zaccarelli Davoli, Sao Paulo (BR); Sebastiao Mendes, Sao Paulo (BR)

(73) Assignee: Cargill, Inc, Waysata (US)

(21) Appl. No.: 13/825,231

(22) PCT Filed: Sep. 24, 2010
(86) PCT No.: PCT/BR10/00314

§ 371 Date: Jun. 5, 2013

(51) Int. Cl. A23L 1/09

(52) U.S. Cl. CPC A23L 1/095
USPC 426/549; 426/658; 426/661; 426/659; 426/565

(57) ABSTRACT

The present invention refers to a fat replacer combination for total or partial substitution of fat in food products such as ice cream and cake comprising: (a) a fat replacer based on carbohydrates for example low DE maltodextrin; (b) one or more emulsifiers for example mono- and diglycerides and optionally propyleneglycol monostearate and (c) one or more stabilizers for example carboxymethylcellulose and guar gum. The present invention also refers to a food product comprising the same.

### TECHNICAL FIELD

The present invention relates to a fat substitute combination that combines a fat replacer based on carbohydrates, one or more emulsifiers and one or more stabilizers to produce a single ingredient that can replace all or part of fat in food products such as ice cream and bakery products.

### BACKGROUND OF THE INVENTION

Fat is a vital element for human metabolism due to its nutritional, functional and organoleptic properties. Among the physiological functions, fat is responsible for transporting fat-soluble vitamins A, D, E and K. The work of fat is also relevant psychologically, once it allows the stomach to be slowly emptied, consequently resulting in the sensation of satiation in people. On the other hand, consumption of high amounts of fat has been linked to the emergence of obesity, hypertension, diabetes, some types of cancer and cardiovascular diseases. Such disorders are usually detected only upon advanced stage, once the accumulation of fats on the wall of the blood vessels may start at an early stage of life and silently develop over the years.

Searching for a longer expectation of life, consumers have become more conscious of the possible health problems resulting from an unbalanced diet and, therefore, they have looked for alimentary products which are low-fat. However, most variants with less fat (or even with no fat at all) commonly have sensorial characteristics that impair not only the taste, but also the looks, color, smell and texture of the product. After all, the physical and chemical properties of certain products are directly linked to the presence of fat in the food matrix which, in turn, implies its processing characteristics (stability upon heating, viscosity, crystallization and aeration properties) and post-processing characteristics (sensitivity to cutting, stickiness, migration and dispersion). Besides, fat is an ingredient which is determinant for the storage stability of a product which may include physical stability (emulsification, migration or separation from fat), chemical stability (rancidity or oxidation) and microbiological stability (water activity and safety). The direct elimination of fat without compensation limits the applicability, depending on the product, and the intended level of fat reduction.

The fat content of a product can be reduced by partially or totally replacing it with a lower energy component. The limited number of food products to which this strategy can be applied led to the development of new methods for reducing fat in certain foods. Keeping the quality of the traditional product, preserving its organoleptic properties, is the main challenge in the development of reduced fat products. Several research have been carried out in order to develop ingredients with fewer calories so that they can replace fat in the preparation of products without—for such purpose—changing the principles that determine their functionality. The purpose of these ingredients, called fat substitutes, is to supply an effective and safe manner of keeping the palatability of foods, wherein their potentiality is usually achieved by using mixtures for specific applications. Therefore, fat substitutes are products which imitate the taste, texture, looks and viscosity, as well as other properties of fat, however, with fewer calories. However, to be used as fat substitute, a molecule needs to be exempt from toxic effects, shall not produce metabolites which are different from those produced by conventional fat, and shall be completely removed from the organism.

There are different types of fat substitutes and their classification is based, mainly, on the chemical nature and on the origin of the product, as well as on its energy value. Fat substitutes may derive from proteins, carbohydrates and synthetic compounds. Apart from these, there is also the group of water-soluble compounds, or hydrocolloids, a group in which most substitutes fit into, except for synthetic compounds and emulsifiers. Most fat substitutes available at the market are based on the ability of structuring the water phase to try to imitate the physical structure and/or the sensorial characteristics of fat. Considering that great part of the alimentary products is comprised by relatively complex systems and that any fat mimetic has limitations in its ability to perform the different tasks of fat, the strategy for fat replacement has evolved because none of the attempts known so far has resulted in a satisfactory final product. In other words, no substitute has been found with significant fat reduction without impairing some quality characteristics of the standard product. Thus, there emerged the method of using a fat substitute together with other ingredients, such as stabilizers and emulsifiers. More recently, this technique has been replaced with the use of more than one fat substitute together with a range of standard ingredients.

To meet the demand of people who desire, in low-calorie products, the same quality of conventional products—such as appropriate taste and texture, lack of cholesterol and low fats—many improvements have been made to develop fat substitutes. Thus, it was discovered that, unlike the fat substitutes derived from proteins which show limited application due to the high temperatures achieved in this process, substitutes based on carbohydrates are thermostable and can be used in baked goods and ice-creams.

U.S. Pat. No. 5,409,726 describes a method of preparing reduced fat foods is provided which employs a fragmented starch hydrolysate. A granular starch hydrolysate or a debranched amylopectin starch precipitate is fragmented to form an aqueous dispersion that is useful in replacing fat in a variety of food formulations. A wet blend of the fragmented starch hydrolysate and a hydrophilic agent is dried. The dry blend can be easily redispersed in water to form a particle gel useful in replacing fat and/or oil in a food formulation. The final replacer is a powder that needs to be rehydrated before being added to the final product so it has the ability to transform into a gel after the rehydration and may thus be incorporated into the final food.

U.S. Pat. No. 6,582,749 describes an edible emulsion having a fat content of less than 5% of weight. An edible fat or oil component is dispersed in an aqueous phase with a two-component emulsifier system comprising a primary emulsifier which acts to stabilize the emulsion and a secondary emulsifier which works in synergy with the fat or oil component to impart a desirable texture and structure to the finished product. The primary emulsifier comprises at least one component selected from the group consisting of proteins, skim milk powder, octenyl succinic acid (OSA), starches, caseinate, whey protein, milk powder, gelatin and gum Arabic; and a secondary emulsifier said secondary emulsifier comprising at least one component selected from the group consisting of mono- and diglycerides, polysorbates, polyglycerol esters, organic acid esters of mono- and diglycerides, propylene glycol esters, stearyl lactylates, lecithin and sucrose fatty acid esters.

EP0441494 describes a low-calorie fat substitute comprised by a two-phase emulsion, comprising a continuous aqueous phase and a dispersed phase, said emulsion containing, carbohydrate, protein, edible fat or oil, and an emulsifier; wherein substantially all of said fat or oil and at least a portion of said protein are in said dispersed phase in the form of protein-fat or protein-oil aggregates; and wherein the non-aggregated protein is either dissolved or suspended in said aqueous phase.

WO 9428741 describes a low fat, low calorie substitute fat food stuff emulsion and method for making the same, the emulsion substantially simulating the appearance, taste, texture, and mouth feel of traditional fat-filled foods. The emulsion can be easily substituted in 1 to 1 proportions for butter, margarine, shortening, oil, lard, cream cheese and other fats called for in many foods. By using butter or margarine in conjunction with maltodextrin, the emulsion (1) avoids the high fat found in lard and/or shortening, (2) retains much if not all of the texture maintained by the fat, yet (3) incorporates more natural products, avoiding certain as emulsifiers which are often used in conjunction with fat substitutes. The low calorie fat substitute basically comprises 40-90% of maltodextrin saccharide polymer by weight and water in the amount of about 5% to 60% by weight. As described, this document is based on the formation of an emulsion as final fat replacer.

WO2008129040 describes an edible fat replacer composition comprising water and a mixture of mono- and diglycerides, both components representing more than 88% by weight and less than 100% by weight, based on the total weight of said fat replacer composition, said mixture of mono- and diglycerides being in an amount comprised between 8% and 60%, said composition further comprising at least one gum for increasing the viscosity in an amount sufficient for reaching 100% by weight. Said gum is selected from the group consisting of microcrystalline cellulose, sodium alginate, locust bean gum, carrageenan, calcium alginate, potassium alginate, propylene glycol alginate, carboxymethylcellulose, methylcellulose, hydroxymethylcellulose, hydroxypropylmethyl cellulose, guar gum, karaya gum, pectin, gelatin carob, tragacanth, arabic and xanthan gum. The document describes a fat replacer that must be produced in water to dissolve the emulsifiers and then it is placed in the final food.

U.S. Pat. No. 5,658,609 describes a fat replacement system for baked goods used as a partial or total fat substitute for baked goods. The fat replacement system comprises the combination of (a) an emulsifier powder which includes a propylene glycol monoester vehicle, mono- and diglycerides, a polyoxyethylene derivative of polyol esters of fatty acids and diacetyl tartaric acid ester of monoglycerides and (b) an unhydrated mixture of vegetable fibers, starch and a gum. The vehicle consists of serum of milk, the vegetable fiber consists of oat fiber, the starch consists of tapioca and the gum consists of xanthan gum. The fat replacement system is present in the batter or dough used to provide baked dough at a level of from about 0.5% to about 5% by weight.

In baked goods, the main problems found in low-fat and sugar reduced foods are: little aeration, fragile cell structure, loss of humidity, poor transfer of heat and reduction of the shelf-life. In the structure of cakes, for instance, fat plays an important role and is directly affected by the quantity used in the formulation. Studies attest that raising the fat level from 20% to 40% improves the quality of cakes when it comes to their softness and taste, producing a fine and more uniform granulation, and also a more humid and silky texture.

In ice-creams, however, the low content of fat interferes in the creamy aspect and taste, texture and resistance to fusion (melting), as well as in the product viscosity. The replacement of fat with protein or carbohydrate changes the physical properties and is of particular interest in frozen dairy desserts. In many systems, the balance between fat and solids in the aqueous phase helps promoting the emulsion's stability during the processing of the mixture and allows fat to destabilize during ice-cream freezing. By replacing the fat, this balance is modified, which affects the melting and battering properties.

BR0511493-4 describes a frozen preparation preserving its softness and showing a reduction in the growth of ice crystals after being exposed to thermal shock and with reduction of the freezing point comprising fat, sweetener, fat-free solid milk and water, in which an emulsifier is used, comprising the use of polyol esters of fatty acids.

EP1787527 describes a process for aerated frozen products comprising the steps of: preparing a mixture of ingredients suitable for preparing a frozen aerated product; adding an emulsifier mixture in a suitable amount to produce a mix, wherein the emulsifier mixture comprises at least propylene glycol monostearate; aerating the mix and freezing the aerated mix to form an aerated frozen product having ice crystals, wherein the ice crystal size is less than about 30 microns.

As noted in previous techniques, it is described low-fat substitute comprising mainly by emulsion or two-phase emulsion, or systems that need to be at a some extent pre-treated before its inclusion into the final food product, and in addition to that replacing fat in a relation to 1:1 (fat replacer:fat). Otherwise, in the present invention, the low-fat substitute comprises a dry combination and has the advantage of being easy to handle, being added to food without changing the production process and without any additional preparation steps; the dry blend also replaces fat in a ratio of 1:3 (fat replacer:fat) by simple replacing the ingredients, giving good flexibility to the process, without the need of revamping all the formulation.

Replacing the functional properties of fat is very difficult and requires mixtures of ingredients which are essential to make up for the lost/replaced properties. The choice of the ingredients depends on the type of product and on the desired level of fat reduction; however, it needs to be carefully balanced against its effects on the multiplicity of the product characteristics.

The market clearly lacks fat substitutes that preserve the organoleptic characteristics of the respective traditional product, so that consumers may have satisfaction in their eating habits combined with improvement of the health related aspects.

### BRIEF DESCRIPTION OF THE INVENTION

The present invention refers to a fat replacer combination for total or partial substitution of fat in food products comprising:
(a) a fat replacer based on carbohydrates;
(b) one or more emulsifiers and
(c) one or more stabilizers.

Such combination is able to imitate the organoleptic properties of fat when it is replaced during the production of foods. Such mixture provides the formulation of a single ingredient which aims at reducing the fat present in cakes and ice-creams, therefore, contributing with the nutritional recommendations on the need of reeducating the eating habits, reducing the fat contained in the daily diets. The technique developed in the present invention has the advantage of replacement at the rate of 1 (one) part of the mixture to 3 (three) parts of fat without the need for additional steps (for example emulsion or dissolution) before proceeding the food production, and this combination substitutes at least 25% to 100% of the fat portion present in food products.

The present invention still refers to a food product having at least part of the fat present substituted by the combination as previously mentioned, for example, iced desserts, cakes, cookies, cake frosting, ice cream, bakery products and desserts in general.

### BRIEF DESCRIPTION OF THE FIGURES

The present invention will be described in more details based on the following figures:

FIG. 1 illustrates a texture analysis for sensory evaluation of cake samples.

FIG. 2 illustrates a density analysis for sensory evaluation of dough cake samples.

FIG. 3 illustrates a volume analysis for sensory evaluation of dough cake samples.

FIG. 4 illustrates analysis of taste, odour and texture for Consumer Sensory Evaluation by using Triangular Method for “Standard” and “Test 2” samples.

### DETAILED DESCRIPTION OF THE INVENTION

The present invention refers to a fat replacer combination for total or partial substitution of fat in food products comprising:
(a) a fat replacer based on carbohydrates;
(b) one or more emulsifiers and
(c) one or more stabilizers.

One preferred embodiment of the invention consists on: one fat replacer based on carbohydrates as low DE maltodextrin 80-85% by weight, one or more emulsifiers as mono and diglycerides 4.5% to 15% by weight and one stabilizer as CMC or guar gum 2% to 10% by weight.

More particularly, the present invention is a result of the study of physical-chemical and sensory properties of a fat substitute developed from the mixture preferentially comprising low DE maltodextrin, guar gum, mono glycerides or mono and diglycerides or propylene glycol monostearate and carboxymethylcellulose for use in cakes and ice cream, but can be applied in other convenient products.

Examples of fat replacer based on carbohydrates that can be used in the invention are: modified starches, starches, enzimatically modified starches, low DE (dextrose equivalent) maltodextrin or mixtures thereof.

Maltodextrin is a polysaccharide that is used as a food additive. It is usually found as creamy-white hygroscopic spraydried powder. Maltodextrin is easily digestible, being absorbed as rapidly as glucose, and might be either moderately sweet or almost flavourless. It is commonly used for the production of natural sodas and candy. Maltodextrins are classified by DE (dextrose equivalent) and have a DE less than 20. (The higher the DE value, the shorter the glucose chains, the higher the sweetness and the higher the solubility.) Above DE 20, the European Unions CN code calls it glucose syrup, at DE 10 or lower the customs CN code nomenclature classifies maltodextrins as dextrins.

The starch which is degraded to smaller molecular weight compounds with DE (has properties that mimic the fat and is also based on carbohydrates. Different properties can be obtained depending on the source of starch used (potatoes, corn, oats, rice, tapioca), and the type and degree of modification applied. Starch granules with a similar diameter to micelles of fat (2 μm) have potential as substitutes for fat. This size is achieved by acid or enzymatic hydrolysis, mechanical friction or microparticulation of starch.

Maltodextrin is a polymer of D-glucose produced by acid or enzymatic hydrolysis of starch. It is used to impart viscosity, increase the soluble solids content, inhibit crystallization and control the freezing point. When used as substitutes of fat, the ratio water: maltodextrin is 3:1, producing a gel whose caloric value is 1 kcal/g or less.

In the present invention, the fat replacer based on carbohydrate is present in the fat substitute in a concentration of about 60% to 90%, preferably 80% to 85% by weight in relation to the total weight of the combination.

The emulsifiers are part of another class of fat replacers in food. They act as auxiliary of the properties of fat, causing a small amount of fat associated with emulsifiers produce the same effect as larger amounts of fat without emulsifiers. Among the many types of emulsifiers that differ by their structure, physical and metabolic properties, the main emulsifiers are based on lipids including mono-and diglycerides, sodium stearoyl lactate and lecitinin. The emulsifiers replace the fat in whole or in part and it is applied in cake mixes, cookies, cake frosting and dairy products. The main emulsifiers used in the invention are mono-glycerides or mono and diglycerides, which may be prepared by known processes involving the reaction of glycerin with certain fats, oils or fatty acids. Another emulsifier, the propylene glycol monostearate is a propylene glycol ester produced from edible refined fatty acids. It acts as an emulsifier, retaining the humidity in baked products, apart from having an excellent property of aeration and stabilization of foam.

In addition of propylene glycol monostearate and/or monoglycerides, and/or mono and diglycerides, other emulsifiers can be used in the invention, such as, polyglycerol ester, sorbitan monostearate, lactic acid esters of monoglycerides or mixture thereof.

The emulsifier is present in the fat replacement system of the invention at a concentration of about 4% to 40%, preferably about 4.5% to 15% by weight in relation to the total weight of the combination.

Stabilizers include substances which enable the maintenance of a homogenous dispersion of two or more immiscible substances in a foodstuff and include also substances which stabilize, retain or intensify an existing colour of a foodstuff. Examples of stabilizers that can be used in the invention are: hydrocolloids, microcrystalline cellulose, locust bean gum, xanthan, polyols, sugars, gelatins or mixture thereof.

A hydrocolloid is defined as a colloid system wherein the colloid particles are dispersed in water. A hydrocolloid has colloid particles spread throughout water, and depending on the quantity of water available that can take place in different states (as gel, for example). Many hydrocolloids are derived from natural sources and they are employed in food mainly to influence texture or viscosity.

Some main hydrocolloids of the invention are: carboxymethylcellulose (CMC), tragacanth, tara, carrageenan, pectin, alginate and its salts, gum arabic, fibers, modified starches, guar gum or mixture thereof.

CMC consists of a polymer derivative of natural cellulose which, unlike cellulose, is highly soluble in water and is used in food science as a viscosity modifier or thickening agent acting as a stabilizer in emulsions of several products, including ice-creams.

Guar gum is part of a fat replacer derived from carbohydrates and is very useful in bakery and frozen products due to its properties of absorbing water. Gums are polymers of long chain and high molecular weight, soluble in water. They provide viscosity, body and in some cases forming gel and have properties to control the rheological characteristics of aqueous systems by means of stabilizing emulsions, suspend particulates, control of crystallization and synergistic inhibition.

In dairy products, for example, yoghurts, desserts and mousses, guar gum inhibits the separation and maintains the texture after sterilization. In frozen foods like ice cream and frozen desserts, guar gum has the primary function of water retention, inhibitor of ice crystals and stabilizer.

In the invention, the stabilizer is present in the powder mixture at a concentration of about 1% to 15%, preferably about 2% to 10% by weight in relation to the total weight of the combination.

The method for obtaining the formulation of the ingredient covered by the present invention comprises, therefore, the mixture of ingredients already known at the food market, however with innovative action when combined with the goal of working as fat substitutes in order to help at the production of low-calorie foods. Furthermore, the fat replacer composition of the invention allows it to be added to the food product without the need to make changes in process for the production thereof.

To check the effects of the present fat substitute, tests that analyzed the behavior of fat replacement in cakes and ice-creams were performed.

The following examples illustrate the present invention, however not limiting the scope of the invention.

### EXAMPLE 1

### Fat Replacer System in Ice-Cream Using the Components of EP1031

A fat replacement system was prepared from a powder and a mixture of 83.76% of low DE maltodextrin, 6.84% of guar gum, 6.84% of mono and diglicerides and 2.56% of CMC, which was coded as EP 1031. Four tests were conducted, considering the standard sample. The concentrations used in the test are described in Table 1. The formulation used to prepare the ice cream is common ingredients like water, sugar, milk powder, whey milk, dried corn syrup, maltodextrin and vanilla flavoring LII 2,080,726), with variation in the ingredients of table 1 (vegetable fat, Lygomme and EP1031).

TABLE 1
concentration of vegetable fat, Lygome
and EP1031 used to perform the test

| | | | | Test 4 (100% |
|---|---|---|---|---|
| | | | | replacement |
| | Test 1 | Test 2 (50% | Test 3 (100% | with increased |
| Ingredient | Standard | replacement) | replacement) | stability) |
| Vegetable | 7% | 3.5% | 0% | 0% |
| fat-Fry | | | | |
| Vitale P400 | | | | |
| Lygomme | 0.6% | 0.6% | 0.6% | 0.8% |
| FM1708 | | | | |
| EP1031 | 0% | 1.16% | 2.33% | 2.33% |

To prepare the ice cream proceeds as follow: heat the water to a temperature approximately between 45 and 50° C. Then add milk and whey milk, followed by the stabilizer mixed into the sugar. Heat the water to about 60° C. with stirring and homogenizer in 150+50 bar. The mixture is then pasteurized in a water bath until it reach 85° C. Pause for 2 minutes. Let cool and mature for 24 hours to beat the ice cream.

Based on internal sensory evaluation it was found that the EP1031 improved the ice cream's performance. Test 2 (50% fat) had a great result. Test 3 (100% fat replacement) had lighter colored, little formation of ice crystals and the sensation of cold is not as pronounced as in previous tests.

It is understood by “internal sensory evaluation test” a test conducted with the help of trained tasters, who have sufficient technical knowledge to evaluate texture, taste and odour in food. On the other hand, the test conducted directly with consumers, i.e, using untrained tasters is called “sensory consumer test” obtained through the triangular method.

Thus, according to the results of this example, there was a preference for the concentration of ingredients obtained from the “Test 2” as the “Test 3” presented emulsifier flavour.

### EXAMPLE 2

### Fat Replacer System in Ice-Cream Using EP1031+PGMS and Sensory Evaluation of the Products

The blend EP1031 has been rebalanced with addition of PGMS, according to the following concentration: 65.60% of low DE maltodextrin, 6.84% of guar gum, 15.00% of mono and diglicerides, 10.00% of propylene glycol monostearate (PGMS) and 2.56% of CMC, which was coded as EP1042.

Five tests were conducted in vanilla ice-cream (Standard, Test A, Test B, Test C and Test D) on the aspects of appearance, colour, odour, flavour and texture. The main objective of this example is to evaluate the performance of a system for fat replacement in the presence or absence of PGMS. The ice cream was prepared according to procedure of Example 1. Tests were conducted in the following concentrations:
Standard—Contains 7% fat
Test A—50% fat reduction with PGMS
Test B—50% fat reduction without PGMS
Test C—0% fat with PGMS
   In the sensory evaluation, the following results were obtained:
Standard: sample showed creamy, smooth filling, flavour explodes in your mouth, showed no ice crystals.
Test A: product closer to the standard, showed good texture and filling, low melting compared to the standard.
Test B: with few crystals of ice, missing body.
Test C: lack body sample, with some ice crystals, brighter colour than the standard sample.
Test D: sample with ice crystals, brighter colour than the standard sample.

The product from Test A (50% fat reduction with PGMS) showed a better performance compared to standard.

### EXAMPLE 3

### Stability Test in Ice Cream with Fat Replacer System Using EP1042

Tests were also conducted in continuous production equipments, to verify if the ice-cream would performing at an industrial scale. The products obtained from the continuous production were evaluated by the following parameters: appearance, colour, taste, odour and stability, the latter to evaluate the shelf life of the product.

The Evaluation of shelf life of all samples were taken weekly until the 4^{th} week to about −8.0° C. for 12 hours and −18.0° C. for 12 hours.

The samples tested are: Standard-Test 01, Test 02 and Test 03 and the results of stability of Test 01, Test 02 and Test 03 to validate the shelf life of the product are shown in Tables 3, 4 and 5 respectively. The results were:
Vanilla Ice Cream—Standard Sample—Test 01: It presents the best behaviour of all. Maintaining excellent creaminess throughout the test.
Vanilla ice cream—3.5% Fat—Test 02: Even with low-fat product behaves very well, while maintaining good creaminess throughout the test period.
Vanilla Ice Cream—Zero Fat—Test 03: Product has difficulty in processing the samples because high viscosity of the mixture (>1000 cP). In the accelerated test sample showed intense creaminess and gumminess acceptable.

Based on the stability test, it is possible to conclude that all samples showed good performance in stability and presented a shelf life greater than four months.

TABLE 2
evaluation of the shelf life of standard sample,
T = −18° C./−8° C. for 12 hours

| Param- | | | | | |
|---|---|---|---|---|---|
| eter | Zero | 1^{st} week | 2^{nd} week | 3^{rd} week | 4^{th} week |
| appear- | dough | dough | OK, no | product | product |
| ance | ice cream | ice cream | shrinkage | in good | in good |
| | | | | condition, | condition, |
| | | | | no | no |
| | | | | shrinkage | shrinkage |
| colour | cream | slightly | slightly | slightly | slightly |
| | | darker | darker | darker, | darker, |
| | | | | same as | same as |
| | | | | 2^{nd} week. | 2^{nd} week |
| Odour | neutral | neutral | Neutral | OK | neutral |
| test | | | | | |
| Flavour | vanilla | vanilla | vanilla | vanilla | vanilla, |
| | caramel, | caramel, | caramel, | caramel | nice |
| | sweet | sweet | sweet | (7) | taste |
| Texture | Creamy, | Creamy, | slightly | Creamy, | Creamy, |
| | excellent | excellent | colder | slightly | slightly |
| | | | than the | sandy | sandy |
| | | | product | | |
| | | | “zero” | | |
| endnote | 7 | 7 | 5 | 6.5. | Approved |
| | | | | Approved | |

TABLE 3
evaluation of the shelf life of “Test 2” sample, with 3.5% of fat,
T = −18° C./−8° C. for 12 hours

| Param- | | | | | |
|---|---|---|---|---|---|
| eter | Zero | 1^{st} week | 2^{nd} week | 3^{rd} week | 4^{th} week |
| appear- | dough | dough | dough ice | product | product |
| ance | ice cream | ice cream | cream, no | in good | in good |
| | | | shrinkage | condition, | condition, |
| | | | | no | no |
| | | | | shrinkage | shrinkage |
| colour | cream | slightly | slightly | slightly | slightly |
| | | darker | darker | darker, | darker, |
| | | | | same as | same as |
| | | | | 2^{nd} week. | 2^{nd} week |
| Odour | neutral | neutral | Neutral | OK | neutral |
| test | | | | | |
| Flavour | vanilla | vanilla | vanilla | vanilla (5) | Intense |
| | caramel, | caramel, | caramel, | | vanilla |
| | with less | with less | with less | | |
| | intensity | intensity | intensity | | |
| | than the | than the | than the | | |
| | standard | standard | standard | | |
| Texture | Creamy, | Creamy, | Creamy, | Creamy, | Creamy, |
| | with | with | with | slightly | slightly |
| | gummy | gummy | gummy | sandy | Sandy |
| | (1-2) | (1-2) | (1-2), | | same as |
| | gummy | | slightly | | 3^{rd} week |
| | | | colder | | |
| endnote | 6 | 6 | 5.5 | Approved | approved |

TABLE 4
evaluation of the shelf life of “Test 3” sample, with 0% of fat,
T = −18° C./−8° C. for 12 hours

| Param- | | | | | |
|---|---|---|---|---|---|
| eter | Zero | 1^{st} week | 2^{nd} week | 3^{rd} week | 4^{th} week |
| appear- | dough | dough | dough ice | product | product |
| ance | ice cream | ice cream | cream, no | in good | in good |
| | | | shrinkage | condition, | condition, |
| | | | | no | no |
| | | | | shrinkage | shrinkage |
| colour | cream | slightly | slightly | slightly | slightly |
| | | darker | darker | darker | darker |
| Odour | neutral | neutral | OK | OK | neutral |
| test | | | | | |
| Flavour | vanilla | vanilla | Same as | vanilla | Vanilla, |
| | caramel, | caramel, | 1^{st} week | (4) | good |
| | with less | with less | | | intensity |
| | intensity | intensity | | | |
| | than the | than the | | | |
| | test 2 | test 2 | | | |
| Texture | Creamy, | Creamy, | Same as | firm | Gummy, |
| | gummy (2) | gummy (2) | 1^{st} week | gummy | sandiness |
| | seems | seems | | Sandy | more |
| | marsh- | marsh- | | (ice | intense |
| | mallow | mallow | | crystals) | than 3^{rd} |
| | | | | | week |
| endnote | 5 | 5 | 5 | Approved | approved |

### EXAMPLE 4

### Application of Fat Replacer System (EP1031) in Cakes

In “English-type cake” it was tested the replacement of 50% fat, compared to a standard with 100% fat. The preparation of the formulation of the fat substitute ingredient used in cake, started with the dosing of all ingredients in powder form. Then the powder ingredients were beaten in the 1st speed (creaming process) until complete homogenisation. The liquid phase was added and beat for 5 minutes in the 3rd speed. Finally, 350 g of dough were placed in individual cake pan and baked for 25 minutes at about 180° C. The formulation used for the cake is described in Table 6.

TABLE 6
guidance formulation for “English” cake adding
the ingredients of the fat replacer system

| Ingredients | Standard | Test 1 | Test 2 |
|---|---|---|---|
| Standard wheat flour | 28.69 | 28.39 | 28.39 |
| Sugar | 22.71 | 22.71 | 22.71 |
| Glucodry | 5.68 | 5.68 | 5.68 |
| Eggs | 17.03 | 17.03 | 17.03 |
| Water | 14.19 | 16.56 | 16.56 |
| Fat CKcake BT | 7.10 | 3.55 | 3.55 |
| Whole milk powder | 1.42 | 1.42 | 1.42 |
| sodium bicarbonate | 0.57 | 0.57 | 0.57 |
| Sodium pyrophosphate | 0.62 | 0.62 | 0.62 |
| Calcium Phosphate | 0.15 | 0.15 | 0.15 |
| Salt | 0.23 | 0.23 | 0.23 |
| Propionate Calcium | 0.26 | 0.26 | 0.26 |
| Vanilla Flavor | 0.23 | 0.23 | 0.23 |
| Sorbitol Liquid | 1.42 | 1.42 | 1.42 |
| Low DE malto | 0 | 0.98 | 0.96 |
| guar gum | 0 | 0.08 | 0.08 |
| emulsifier mono and di | 0 | 0.08 | 0.1 |
| CMC | 0 | 0.03 | 0.03 |

After internal sensory evaluation is possible to verify that the products obtained in “Test 2” and “Test 3” have sensory characteristics and physicochemical properties similar to the standard product.

### EXAMPLE 5

### Application of Fat Replacer System (EP1031) in Cakes with Other Emulsifiers

In this test was added PGMS and mono and dimyverol to verify their sensory performance.

The internal Sensory Analysis examined four samples of cakes (Standard, Test 1, Test 2 and Test 3) on the aspects of texture, density and volume. The evaluation of the shelf life of four samples was performed after 1, 5 and 12 days. All forms of cake were weighed 350 g each, all of whom underwent 25 minutes of baking at about 180° C. According to the results of sensory analysis, the product that showed better performance compared to the standard sample was the second Test.

Table 7 shows different kind of blends to verify the synergism among emulsifiers within the EP1031 system.

TABLE 7

| | Blend 1 | Blend 2 | Blend 3 |
|---|---|---|---|
| EP1031 | 70.60% | 65.60% | 65.60% |
| Goma Guar | 6.84% | 6.84% | 6.84% |
| Mono and di myverol | 10% | 15% | 10% |
| PGMS | 10% | 10% | 15% |
| CMC | 2.56% | 2.56% | 2.56% |

The samples were tested with replacement of 50% fat, varying the type and concentration of emulsifiers in the EP1031, as described below:
Standard: Pan Advance S650E=7.10%
Test01: Pan Advance S650E 3.75%+EP1031 (Blend 1) 1.18%
Test02: Pan Advance S650E 3,75%+EP1031 (Blend 2) 1.18%
Test03: Pan Advance S650E 3.75%+EP1031 (Blend 3) 1.18%

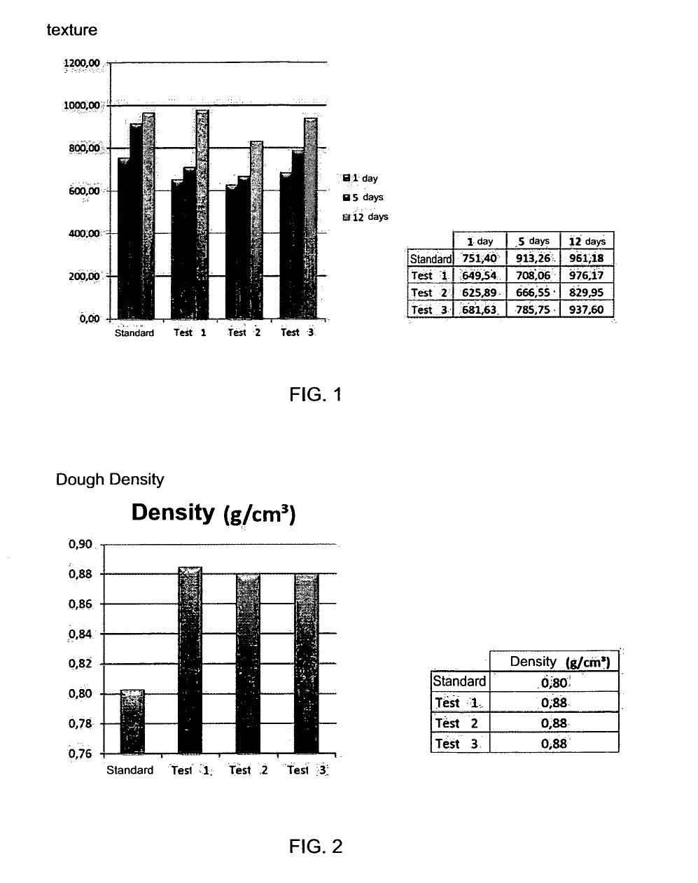

The results for performance evaluation of texture, density and volume are described in FIGS. 1 and 2 respectively. The tests performed with different blend of emulsifiers on the system's EP1031, provided a greater synergy in the proportion of “test 2”.

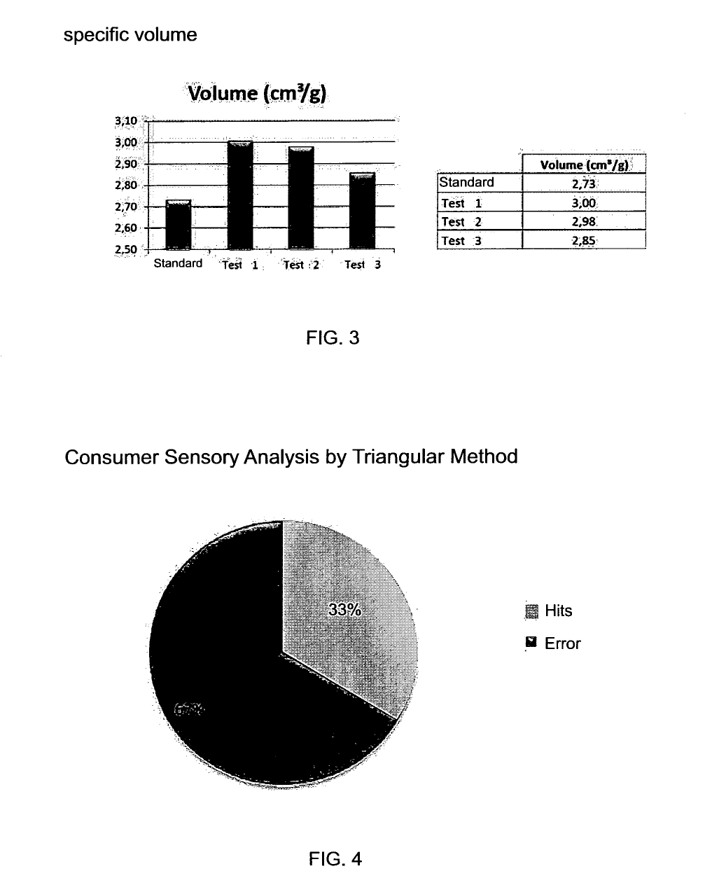

After the Internal Sensory Evaluation, we chose to implement the Consumer Sensory Analysis by using the Triangular Method for Standard and “Test 2”. The results obtained by the triangular method are described in FIG. 3

We verify that 67% of the taster could not distinguish the difference between the Standard and Test 2 samples on the general aspects of taste, odour and texture. There was no difference between samples at 5% significance level.

Based on the result of sensory test by triangular method (using consumer test, that is, untrained tasters) showed good performance of the mixture in the matters of taste, smell and texture of the samples because the vast majority of tasters could not distinguish the difference between the samples submitted. The blend of Test 2 was coded as EP1040.

### EXAMPLE 6

### Sensory Evaluation (Acceptance) of EP 1040 in Cake Samples

Sensory analysis was performed consisting of an acceptance test with untrained consumers, who evaluated the taste and texture of cakes containing the fat replacer of the invention.

Three sensorial analyses were performed-: 1) one day after the manufacturing date of the cake (1° test); 2) in the middle of the shelflife at the 20^{th} day (2° test) and 3) near the end of shelf life of the cake at the 33^{th} day (3° test)
The 9-point hedonic scale, commonly used in sensory evaluation of food for acceptance tests, was used on the scale of texture and flavour as described in table 8.

TABLE 8
Scale of texture and flavour used in the sensory analysis.

| Texture | Flavour |
|---|---|
| 9. Like extremely. | 9. Like extremely. |
| 8. Like very much. | 8. Like very much. |
| 7. Like moderately. | 7. Like moderately. |
| 6. Liked slightly.. | 6. Liked slightly.. |
| 5. Neither like nor dislike. | 5. Neither like nor dislike. |
| 4. Disliked slightly. | 4. Disliked slightly. |
| 3. Dislike moderately | 3. Dislike moderately |
| 2. Dislike very much. | 2. Dislike very much. |
| 1. Dislike extremely | 1. Dislike extremely |

The results were analysed using common statistical tools used in sensory evaluation of foods, as ANOVA (Analysis of Variance) table and F test, that are able to evaluate if there is or there isn't differences between the means of three or more samples that are being analysed. If F value is lower than F critical, so there is no difference between samples at a certain level of significance (it is commonly accepted a level of 5% of significance in this kind of test). If F value is greater than F critical, so there is at least one sample that differs from another sample inside the samples that are being analyzed.

However, ANOVA table does not tell where the difference lies between the samples. If the ANOVA table shows that there is some difference between samples, so there is a need of applying another test, as for example the Tukey test, that are able to discriminate which samples are different of each one. In the Tukey test, it is calculated a minimal significant difference (MSD) to compare the mean of the analysed samples: if the difference between the means of the analysed samples are greater than MSD, so it is considered that there is a difference between samples that are being compared, but if the difference between the means of the analysed samples are lower than MSD, so it is considered that there isn't any difference between the samples that are being compared.

Result of acceptance of texture and flavour (1° test):

The samples were coded as: 397—Standard, 815—30% fat reduction and 561—50% fat reduction, with 1 day of shelf life.

TABLE 9
result of acceptance of texture-1° test

| Taster | 397 | 815 | 561 |
|---|---|---|---|
| 1 | 7 | 7 | 7 |
| 2 | 8 | 9 | 9 |
| 3 | 9 | 6 | 7 |
| 4 | 7 | 7 | 7 |
| 5 | 6 | 7 | 6 |
| 6 | 7 | 8 | 8 |
| 7 | 7 | 4 | 7 |
| 8 | 8 | 7 | 7 |
| 9 | 7 | 7 | 7 |
| 10 | 8 | 7 | 8 |
| 11 | 8 | 7 | 5 |
| 12 | 3 | 3 | 3 |
| 13 | 7 | 6 | 7 |
| 14 | 5 | 4 | 3 |
| 15 | 8 | 8 | 8 |
| 16 | 8 | 1 | 1 |
| 17 | 9 | 9 | 9 |
| 18 | 8 | 7 | 8 |
| 19 | 7 | 6 | 5 |
| 20 | 8 | 5 | 5 |
| 21 | 8 | 8 | 9 |
| 22 | 7 | 7 | 7 |
| 23 | 8 | 8 | 8 |
| 24 | 8 | 7 | 7 |
| 25 | 8 | 6 | 8 |
| 26 | 7 | 5 | 5 |
| 27 | 8 | 6 | 6 |
| 28 | 8 | 9 | 9 |
| 29 | 8 | 9 | 9 |
| 30 | 6 | 6 | 6 |
| 31 | 9 | 8 | 8 |
| 32 | 8 | 6 | 7 |
| 33 | 3 | 4 | 5 |
| 34 | 7 | 8 | 8 |
| 35 | 8 | 7 | 2 |
| 36 | 9 | 9 | 9 |
| 37 | 8 | 8 | 8 |
| 38 | 3 | 8 | 8 |
| 39 | 6 | 8 | 7 |
| 40 | 5 | 7 | 6 |
| 41 | 7 | 7 | 7 |
| 42 | 6 | 7 | 8 |
| 43 | 7 | 8 | 8 |
| 44 | 8 | 5 | 6 |
| 45 | 7 | 8 | 8 |
| 46 | 8 | 8 | 9 |
| 47 | 8 | 7 | 7 |
| 48 | 6 | 7 | 6 |
| 49 | 8 | 6 | 6 |
| 50 | 8 | 6 | 6 |
| average | 7.2 | 6.8 | 6.8 |

TABLE 10
result of analysis of variance (ANOVA) - texture -1° test

| Variance source | SS | DF | MS | F | value-P | Fcritical |
|---|---|---|---|---|---|---|
| taster | 257.6871 | 48 | 5.368481 | 3.98611 | 4.19E−09 | 1.488853 |
| sample | 6.040816 | 2 | 3.020408 | 2.24266 | 0.11171 | 3.091188 |
| error | 129.2925 | 96 | 1.346797 | | | |
| total | 393.0204 | 146 | | | | |

SS—sum of squares;
DF—degree of freedom;
MS—mean of squares

The F value (2.24) of the sample is less than the F critical (3.09), thus, it is possible to conclude that t here is no significant difference in the acceptance of three samples of cakes with respect to the texture. The acceptance of the Standard, the sample with 30% fat reduction and the sample with 50% fat reduction was “liked moderately”.

TABLE 11
result of acceptance of flavour-1° test

| Taster | 397 | 815 | 561 |
|---|---|---|---|
| 1 | 7 | 7 | 8 |
| 2 | 8 | 9 | 7 |
| 3 | 8 | 7 | 4 |
| 4 | 7 | 7 | 8 |
| 5 | 8 | 6 | 8 |
| 6 | 4 | 8 | 7 |
| 7 | 7 | 7 | 7 |
| 8 | 8 | 7 | 6 |
| 9 | 7 | 7 | 8 |
| 10 | 8 | 8 | 8 |
| 11 | 7 | 5 | 5 |
| 12 | 4 | 3 | 6 |
| 13 | 4 | 7 | 6 |
| 14 | 8 | 3 | 5 |
| 15 | 7 | 8 | 8 |
| 16 | 8 | 1 | 2 |
| 17 | 7 | 9 | 8 |
| 18 | 7 | 8 | 7 |
| 19 | 6 | 5 | 7 |
| 20 | 8 | 5 | 8 |
| 21 | 8 | 9 | 9 |
| 22 | 7 | 7 | 7 |
| 23 | 8 | 8 | 8 |
| 24 | 8 | 7 | 9 |
| 25 | 8 | 8 | 8 |
| 26 | 7 | 5 | 6 |
| 27 | 8 | 6 | 9 |
| 28 | 9 | 9 | 9 |
| 29 | 8 | 9 | 8 |
| 30 | 6 | 6 | 6 |
| 31 | 9 | 8 | 7 |
| 32 | 9 | 7 | 9 |
| 33 | 4 | 5 | 8 |
| 34 | 8 | 8 | 7 |
| 35 | 7 | 2 | 7 |
| 36 | 7 | 9 | 9 |
| 37 | 8 | 8 | 8 |
| 38 | 8 | 8 | 7 |
| 39 | 7 | 7 | 6 |
| 40 | 5 | 6 | 7 |
| 41 | 7 | 7 | 7 |
| 42 | 6 | 8 | 6 |
| 43 | 7 | 8 | 7 |
| 44 | 8 | 6 | 7 |
| 45 | 7 | 8 | 7 |
| 46 | 8 | 9 | 7 |
| 47 | 8 | 7 | 7 |
| 48 | 6 | 6 | 8 |
| 49 | 8 | 6 | 9 |
| 50 | 8 | 6 | 5 |
| average | 7.2 | 6.8 | 7.1 |

TABLE 12
result of analysis of variance (ANOVA) - flavour -1° test

| Variance source | SS | DF | MS | F | value-P | Fcritical |
|---|---|---|---|---|---|---|
| lines | 176.4218 | 48 | 3.675454 | 2.309761 | 0.000254 | 1.488853 |
| colums | 4.571429 | 2 | 2.285714 | 1.436409 | 0.242844 | 3.091188 |
| error | 152.7619 | 96 | 1.59127 | | | |
| total | 333.7551 | 146 | | | | |

SS—sum of squares;
DF—degree of freedom;
MS—mean of squares

The F value (1.44) of the sample is less than the F critical (3.09), thus, it is possible to conclude that there is no significant difference in the acceptance of three samples of cakes with respect to the flavour. The acceptance of the Standard, the sample with 30% fat reduction and the sample with 50% fat reduction was “liked moderately”.

Result of acceptance of texture and flavour (2° test):

The samples were coded as: 397—Standard, 815—30% fat reduction and 561—50% fat reduction, with 22 days of shelf life.

TABLE 13
result of acceptance of texture -2° test

| Taster | 397 | 815 | 561 |
|---|---|---|---|
| 1 | 3 | 4 | 4 |
| 2 | 6 | 2 | 3 |
| 3 | 7 | 6 | 4 |
| 4 | 7 | 7 | 7 |
| 5 | 8 | 7 | 5 |
| 6 | 6 | 8 | 6 |
| 7 | 7 | 6 | 4 |
| 8 | 7 | 8 | 6 |
| 9 | 6 | 3 | 3 |
| 10 | 6 | 1 | 4 |
| 11 | 8 | 8 | 6 |
| 12 | 7 | 4 | 4 |
| 13 | 8 | 4 | 6 |
| 14 | 6 | 6 | 7 |
| 15 | 7 | 8 | 6 |
| 16 | 7 | 6 | 6 |
| 17 | 8 | 9 | 8 |
| 18 | 7 | 7 | 7 |
| 19 | 4 | 4 | 3 |
| 20 | 7 | 8 | 4 |
| 21 | 7 | 8 | 7 |
| 22 | 7 | 9 | 9 |
| 23 | 8 | 8 | 9 |
| 24 | 6 | 7 | 8 |
| 25 | 7 | 6 | 8 |
| 26 | 7 | 3 | 4 |
| 27 | 9 | 9 | 8 |
| 28 | 8 | 7 | 7 |
| 29 | 7 | 4 | 7 |
| 30 | 7 | 6 | 7 |
| 31 | 7 | 2 | 2 |
| 32 | 7 | 8 | 6 |
| 33 | 7 | 6 | 6 |
| 34 | 7 | 7 | 8 |
| 35 | 8 | 8 | 7 |
| 36 | 9 | 9 | 9 |
| 37 | 7 | 6 | 4 |
| 38 | 7 | 4 | 3 |
| 39 | 7 | 6 | 8 |
| 40 | 8 | 8 | 9 |
| 41 | 6 | 6 | 8 |
| 42 | 8 | 8 | 7 |
| 43 | 8 | 7 | 6 |
| 44 | 7 | 8 | 5 |
| 45 | 6 | 7 | 7 |
| 46 | 9 | 4 | 8 |
| 47 | 8 | 6 | 7 |
| 48 | 7 | 6 | 6 |
| 49 | 8 | 8 | 7 |
| 50 | 8 | 9 | 8 |
| average | 7.08 | 6.32 | 6.16 |

TABLE 14
result of analysis of variance (ANOVA) - texture -2° test

| Vari- | | | | | | |
|---|---|---|---|---|---|---|
| ance | | | | | | |
| source | SS | DF | MS | F | value-P | Fcritical |
| lines | 261.8503 | 48 | 5.455215 | 3.735637 | 2E−08 | 1.488853 |
| columns | 25.80952 | 2 | 12.90476 | 8.836957 | 0.0003 | 3.091188 |
| error | 140.1905 | 96 | 1.460317 | | | |
| total | 427.8503 | 146 | | | | |

SS—sum of squares;
DF—degree of freedom;
MS—mean of squares

The F value (8.83) of the sample is greater than the F critical (3.09), thus, it is possible to conclude that there is a significant difference (at 5%) in relation to texture acceptance

Tukey test:
MSD=0.57
   |397-815|=0.76 greater than 0.57 (the averages differ)
   |397-561|=0.92 greater than 0.57 (the averages differ)
   |815-561|=0.16 less than 0.57 (the averages do not differ)

The acceptability of the texture of the sample 397 (standard) differs significantly with respect to samples 815 and 561. The standard sample was classified as “moderately liked” category and the other samples as “liked slightly” category.

TABLE 15
result of acceptance of flavour -2° test

| Taster | 397 | 815 | 561 |
|---|---|---|---|
| 1 | 7 | 4 | 4 |
| 2 | 7 | 2 | 3 |
| 3 | 6 | 8 | 4 |
| 4 | 6 | 6 | 6 |
| 5 | 8 | 8 | 4 |
| 6 | 7 | 7 | 8 |
| 7 | 7 | 7 | 6 |
| 8 | 8 | 8 | 6 |
| 9 | 6 | 7 | 6 |
| 10 | 6 | 2 | 4 |
| 11 | 8 | 8 | 7 |
| 12 | 8 | 7 | 7 |
| 13 | 7 | 8 | 7 |
| 14 | 5 | 6 | 7 |
| 15 | 7 | 7 | 7 |
| 16 | 7 | 5 | 6 |
| 17 | 8 | 9 | 8 |
| 18 | 7 | 7 | 7 |
| 19 | 6 | 7 | 7 |
| 20 | 9 | 7 | 4 |
| 21 | 7 | 8 | 8 |
| 22 | 9 | 9 | 9 |
| 23 | 7 | 8 | 9 |
| 24 | 4 | 8 | 8 |
| 25 | 8 | 7 | 7 |
| 26 | 6 | 4 | 4 |
| 27 | 9 | 8 | 8 |
| 28 | 8 | 7 | 6 |
| 29 | 5 | 4 | 6 |
| 30 | 5 | 5 | 6 |
| 31 | 8 | 6 | 4 |
| 32 | 7 | 6 | 5 |
| 33 | 7 | 7 | 5 |
| 34 | 8 | 8 | 8 |
| 35 | 8 | 6 | 8 |
| 36 | 8 | 7 | 9 |
| 37 | 7 | 6 | 4 |
| 38 | 7 | 6 | 3 |
| 39 | 7 | 8 | 9 |
| 40 | 8 | 8 | 9 |
| 41 | 6 | 6 | 6 |
| 42 | 8 | 7 | 8 |
| 43 | 7 | 7 | 6 |
| 44 | 8 | 8 | 7 |
| 45 | 7 | 8 | 6 |
| 46 | 9 | 7 | 6 |
| 47 | 8 | 8 | 7 |
| 48 | 6 | 5 | 6 |
| 49 | 8 | 9 | 8 |
| 50 | 8 | 9 | 8 |
| average | 7.16 | 6.80 | 6.42 |

TABLE 16
result of analysis of variance (ANOVA) - flavour -2° test

| Variance source | SS | DF | MS | F | value-P | Fcritical |
|---|---|---|---|---|---|---|
| lines | 190.7483 | 48 | 3.973923 | 3.175178 | 7.46E−07 | 1.488853 |
| columns | 11.85034 | 2 | 5.92517 | 4.734232 | 0.010943 | 3.091188 |
| error | 120.1497 | 96 | 1.251559 | | | |
| total | 322.7483 | 146 | | | | |

SS—sum of squares;
DF—degree of freedom;
MS—mean of squares

The F value (4.73) of the sample is greater than the F critical (3.09), thus, it is possible to conclude that there is a significant difference (at 5%) in relation to flavour acceptance.

Tukey test:
MSD=0.52
   |397-815|=0.36 less than 0.57 (the averages do not differ)
   |397-561|=0.74 greater than 0.57 (the averages differ)
   |815-561|=0.38 less than 0.57 (the averages do not differ)

In relation to flavor, there is no difference in the acceptability of the standard sample and 30% of fat reduction.

Comparing the sample with 30% fat reduction with 50% fat reduction, there is no difference in acceptability between the samples, however there is difference between the standard and 50% of fat reduction.

The standard sample and 815 sample were classified as “moderately liked” category and the 561 sample was classified as “liked slightly” category.

Result of acceptance of texture and flavour (3° test):

The samples were coded as: 397—Standard, 815—30% fat reduction and 561—50% fat reduction, with 33 days of shelf life.

TABLE 17
result of acceptance of texture -3° test

| Taster | 397 | 815 | 561 |
|---|---|---|---|
| 1 | 6 | 7 | 7 |
| 2 | 7 | 7 | 6 |
| 3 | 7 | 8 | 5 |
| 4 | 7 | 7 | 7 |
| 5 | 2 | 4 | 4 |
| 6 | 7 | 7 | 7 |
| 7 | 4 | 3 | 4 |
| 8 | 5 | 6 | 3 |
| 9 | 4 | 4 | 4 |
| 10 | 9 | 8 | 7 |
| 11 | 3 | 6 | 3 |
| 12 | 7 | 6 | 6 |
| 13 | 7 | 7 | 3 |
| 14 | 4 | 3 | 2 |
| 15 | 6 | 7 | 6 |
| 16 | 6 | 5 | 7 |
| 17 | 7 | 8 | 5 |
| 18 | 6 | 3 | 2 |
| 19 | 9 | 8 | 6 |
| 20 | 8 | 7 | 6 |
| 21 | 6 | 7 | 5 |
| 22 | 7 | 7 | 2 |
| 23 | 8 | 9 | 7 |
| 24 | 1 | 2 | 3 |
| 25 | 7 | 7 | 4 |
| 26 | 8 | 9 | 6 |
| 27 | 7 | 7 | 6 |
| 28 | 4 | 7 | 5 |
| 29 | 8 | 6 | 7 |
| 30 | 7 | 2 | 2 |
| 31 | 7 | 6 | 5 |
| 32 | 5 | 7 | 7 |
| 33 | 9 | 8 | 8 |
| 34 | 8 | 8 | 8 |
| 35 | 7 | 6 | 6 |
| 36 | 8 | 8 | 7 |
| 37 | 7 | 7 | 6 |
| 38 | 7 | 7 | 6 |
| 39 | 9 | 8 | 8 |
| 40 | 8 | 7 | 7 |
| 41 | 7 | 8 | 6 |
| 42 | 9 | 8 | 9 |
| 43 | 7 | 6 | 6 |
| 44 | 8 | 8 | 8 |
| 45 | 8 | 8 | 7 |
| 46 | 4 | 8 | 8 |
| 47 | 9 | 9 | 8 |
| 48 | 9 | 7 | 7 |
| 49 | 8 | 8 | 6 |
| 50 | 7 | 7 | 4 |
| average | 6.7 | 6.7 | 5.7 |

TABLE 18
result of analysis of variance (ANOVA) - texture -3° test

| Variance source | SS | DF | MS | F | value-P | Fcritical |
|---|---|---|---|---|---|---|
| taster | 362.3265 | 48 | 7.548469 | 6.25361 | 1.49E−14 | 1.488853 |
| sample | 34.78912 | 2 | 17.39456 | 14.41071 | 3.37E−06 | 3.091188 |
| error | 115.8776 | 96 | 1.207058 | | | |
| total | 512.9932 | 146 | | | | |

SS—sum of squares;
DF—degree of freedom;
MS—mean of squares

The F value (14,4) of the sample is greater than the F critical (3.09), thus, it is possible to conclude that there is a significant difference (at 5%) in relation to texture acceptance.

Tukey test:
MSD=0.52
   |397-815|=0.0 less than 0.52 (the averages do not differ)
   |397-561|=1.0 greater than 0.52 (the averages differ)
   |815-561|=1.0 greater than 0.52 (the averages differ)

With respect to texture in the third test, the standard sample and with 30% of fat reduction sample do not differ significantly (p<0.05). However, the 50% fat reduction sample compared to the standard, showed a significance difference (p<0.05). Similarly the sample with 30% of fat reduction and 50% of fat reduction also showed a significance difference (p<0.05).

The standard sample was classified as “moderately liked” category and the other samples as “liked slightly” category.

TABLE 19
result of acceptance of flavour -3° test

| Taster | 397 | 815 | 561 |
|---|---|---|---|
| 1 | 4 | 6 | 7 |
| 2 | 8 | 7 | 8 |
| 3 | 8 | 8 | 4 |
| 4 | 8 | 7 | 6 |
| 5 | 7 | 7 | 6 |
| 6 | 7 | 8 | 7 |
| 7 | 6 | 4 | 6 |
| 8 | 5 | 6 | 3 |
| 9 | 4 | 4 | 6 |
| 10 | 9 | 8 | 7 |
| 11 | 6 | 3 | 6 |
| 12 | 8 | 8 | 8 |
| 13 | 6 | 7 | 2 |
| 14 | 4 | 7 | 2 |
| 15 | 7 | 8 | 6 |
| 16 | 8 | 7 | 6 |
| 17 | 7 | 8 | 7 |
| 18 | 6 | 6 | 4 |
| 19 | 8 | 7 | 8 |
| 20 | 8 | 9 | 8 |
| 21 | 6 | 7 | 5 |
| 22 | 8 | 7 | 4 |
| 23 | 8 | 8 | 8 |
| 24 | 1 | 2 | 4 |
| 25 | 8 | 6 | 4 |
| 26 | 9 | 8 | 6 |
| 27 | 8 | 8 | 6 |
| 28 | 4 | 7 | 5 |
| 29 | 8 | 6 | 7 |
| 30 | 3 | 2 | 2 |
| 31 | 8 | 5 | 7 |
| 32 | 7 | 6 | 5 |
| 33 | 9 | 7 | 9 |
| 34 | 9 | 7 | 8 |
| 35 | 8 | 8 | 7 |
| 36 | 8 | 7 | 8 |
| 37 | 8 | 6 | 5 |
| 38 | 7 | 7 | 8 |
| 39 | 9 | 8 | 7 |
| 40 | 8 | 8 | 8 |
| 41 | 8 | 8 | 7 |
| 42 | 9 | 9 | 9 |
| 43 | 8 | 6 | 6 |
| 44 | 8 | 8 | 8 |
| 45 | 8 | 8 | 8 |
| 46 | 3 | 6 | 7 |
| 47 | 9 | 9 | 8 |
| 48 | 9 | 8 | 8 |
| 49 | 8 | 6 | 7 |
| 50 | 9 | 9 | 4 |
| average | 7.1 | 6.8 | 6.2 |

TABLE 20
result of analysis of variance (ANOVA) - flavour -3° test

| Variance | | | | | | |
|---|---|---|---|---|---|---|
| source | SS | DF | MS | F | value-P | Fcritical |
| lines | 316.6667 | 48 | 6.597222 | 4.732615 | 4.94E−11 | 1.488853 |
| columns | 24.17687 | 2 | 12.08844 | 8.671818 | 0.000345 | 3.091188 |
| error | 133.8231 | 96 | 1.393991 | | | |
| total | 474.6667 | 146 | | | | |

SS—sum of squares; DF—degree of freedom; MS—mean os squares

The F value (8.67) of the sample is greater than the F critical (3.09), thus, it is possible to conclude that there is a significant difference (at 5%) in relation to flavour acceptance.

Tukey test:
MDS=0.55
   |397-815|=0.3 less than 0.55 (the averages do not differ)
   |397-561|=0.9 greater than 0.55(the averages differ)
   |815-561|=0.6 greater than 0.55 (the averages differ)

In relation to flavor, there is no difference in the acceptability of the standard sample and 30% of fat reduction (p<0.05).

Comparing the standard sample with 50% fat reduction, there is a difference in acceptability between the samples (p>0.05). Similarly the sample with 30% of fat reduction and 50% of fat reduction also showed a significance difference in relation to flavour.

The standard sample and 815 sample were classified as “moderately liked” category and the other samples were classified as “liked slightly” category.

Although the foregoing has been described in some detail by way of illustration for purposes of clarity of understanding, it will be apparent that various changes and modifications may be practiced within the scope of the appended claims.

1.-15. (canceled)

16. A fat replacer composition for total or partial substitution of fat in food products comprising:
(a) a fat replacer based on carbohydrates;
(b) an emulsifier; and
(c) a stabilizer.

17. The fat replacer composition of claim 16, wherein the fat replacer based on carbohydrates is selected from the group consisting of low DE maltodextrin, modified starches, starches, enzymatically modified starches, and mixtures thereof.

18. The fat replacer composition of claim 16, wherein the emulsifier is selected from the group consisting of propylene glycol monostearate, monoglycerides, diglycerides, polyglycerol ester, sorbitan monostearate, lactic acid esters of monoglycerides, and mixtures thereof.

19. The fat replacer composition of claim 16, wherein the stabilizer is selected from the group consisting of hydrocolloids, microcrystalline cellulose, locust bean gum, xanthan, polyols, sugars, gelatins, and mixtures thereof.

20. The fat replacer composition of claim 19, wherein the hydrocolloid is selected from the group consisting of carboxymethylcellulose (CMC), tragacanth, tara, carrageenan, pectin, alginate and its salts, gum arabic, fibers, modified starches, guar gum, and mixtures thereof.

21. The fat replacer composition of claim 17, wherein the fat replacer based on carbohydrates is present in a concentration of between 60% and 90% by weight in relation to the total weight of the composition.

22. The fat replacer composition of claim 21, wherein the fat replacer based on carbohydrates is present in a concentration of between 80% and 85% by weight in relation to the total weight of the composition.

23. The fat replacer composition of claim 18, wherein the emulsifier is present in a concentration of from about 4% to 40% by weight in relation to the total weight of the composition.

24. The fat replacer composition of claim 23, wherein the emulsifier is present in a concentration of from about 4.5% to 15% by weight in relation to the total weight of the composition.

25. The fat replacer composition of claim 20, wherein the stabilizer is present in a concentration of from about 1% to 15% by weight in relation to the total weight of the composition.

26. The fat replacer composition of claim 25, wherein stabilizer is present in a concentration of from about 2% to 10% by weight in relation to the total weight of the composition.

27. The fat replacer composition of claim 16, wherein the composition is in the form of a powder.

28. The fat replacer composition of claim 16, wherein the composition substitutes fat in a proportion of 1:3 (1 part of composition: 3 parts of fat).

29. The fat replacer composition of claim 16, wherein the composition substitutes at least 25% to 100% of the fat portion present in a food product.

30. A food product comprising fat, wherein at least part of the fat is substituted by the composition of claim 16, and wherein the food product is selected from the group consisting of dessert, iced desserts, cakes, cookies, cake frosting, ice cream, and bakery products.
